(19) United States
(12) Patent Application Publication
(10) Pub. No.: US 2009/0034180 A1
(43) Pub. Date: Feb. 5, 2009

(54) Plasma display device

(76) Inventor: Kwang-Gouk Lee, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/222,049

(22) Filed: Jul. 31, 2008

(30) Foreign Application Priority Data
Jul. 31, 2007 (KR) 10-2007-0077027

(51) Int. Cl. G06F 1/16

(52) U.S. Cl. 361/681

(57) ABSTRACT

A plasma display device including a plasma display panel having a front panel and a rear panel; a chassis base installed in one surface of the plasma display panel to support the plasma display panel; a driving circuit board installed in the other surface of the chassis base and driving the plasma display panel; a signal coupling means for electrically coupling the driving circuit board to an electrode of the plasma display panel, the signal coupling means having driver ICs; and a signal coupling cover that surrounds and protect the signal coupling means and has at least one extension formed in an inner surface other than a region corresponding to the driver IC. Therefore, the plasma display device improves the quality of articles by significantly reducing noises.

### CLAIM OF PRIORITY

This application makes reference to, incorporates the same herein, and claims all benefits accruing under 35 U.S.C. §119 from an application for PLASMA DISPLAY DEVICE earlier filed in the Korean Intellectual Property Office on 31 Jul. 2007 and there duly assigned Serial No. 10-2007-0077027.

### BACKGROUND OF THE INVENTION

1. Field of the Invention

The present invention relates to a plasma display device, and more particularly to a plasma display device having a driver integrated circuit (IC) installed as a tape carrier package (hereinafter, referred to as TCP).

2. Description of the Related Art

In general, a plasma display panel (PDP) is a display panel that displays an image by exciting a phosphor using the vacuum ultraviolet rays generated by the gas discharge that appears in discharge cells, and it has a display capacity and excellent physical properties such as luminance, contrast, viewing angle, etc., and may be manufactured to have a large screen with thin thickness and light weight.

This plasma display device includes a plasma display panel for displaying an image; a chassis base for supporting the plasma display panel; a plurality of circuit boards installed in the chassis base and including various driver circuit units; and front and rear covers that surround and protect the plasma display panel, the chassis base and the circuit board.

An electrode extracted from an edge of the plasma display panel is electrically coupled to a driving circuit board having a driver element through a flexible printed circuit board, and supplied with a signal that is required for driving the plasma display panel.

A plurality of driver ICs are disposed in the flexible printed circuit board, wherein the driver ICs selectively applies a voltage to the electrode of the plasma display panel, depending on the signal controlled in the driving circuit board. These driver ICs are packaged in a conventional TCP type, and electrically coupled to a plasma display panel and a circuit board having driver elements through the flexible printed circuit board. Also, a TCP cover is coupled to the chassis base to protect TCP.

However, The plasma display device as configured thus has a problem that, if the driver ICs composing the TCP are switched at a high speed, then vibrations are delivered to the flexible printed circuit board, and noises are produced while the flexible printed circuit board is in contact with the TCP cover. Also, the noises lead to deterioration in quality of articles.

### SUMMARY OF THE INVENTION

Accordingly, the present invention is designed to solve such drawbacks of the prior art, and therefore an object of the present invention is to provide a plasma display device in which a TCP cover is modified to prevent “the TCP cover and the film-type flexible printed circuit board from being in contact to each other to produce noises”, when the driver integrated circuits (ICs) composing TCP are switched at a high speed.

One embodiment of the present invention is achieved by providing a plasma display device including a plasma display panel having a front panel and a rear panel; a chassis base installed in one surface of the plasma display panel to support the plasma display panel; a driving circuit board installed in the other surface of the chassis base and driving the plasma display panel; a signal coupling means for electrically coupling the driving circuit board to an electrode of the plasma display panel, the signal coupling means having driver ICs; and a signal coupling cover that surrounds and protect the signal coupling means and has at least one extension formed in an inner surface other than a region corresponding to the driver IC. Another embodiment of the present invention is achieved by providing a plasma display device, comprising: a plasma display panel having a front panel and a rear panel; a chassis base installed in one surface of the plasma display panel to support the plasma display panel; a driving circuit board installed in the other surface of the chassis base to drive the plasma display panel; a tape carrier package to electrically couple the driving circuit board to an electrode of the plasma display panel, the tape carrier package being coupled to a driver integrated circuit; and a signal coupling cover that surrounds and protect the tape carrier package and has at least one extension formed in an inner surface other than a region corresponding to the driver integrated circuit, wherein said at least one extension prevents noise and vibration generated by the driver integrated circuit from being transmitted to a flexible printed circuit board and the signal coupling cover by preventing the tape carrier package and the signal coupling cover from coming into contact.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view showing a plasma display panel according to one embodiment of the present invention.

FIG. 2 is a cross-sectional view showing one aspect taken from a line A-A′ as shown in FIG. 1.

FIG. 3 is a cross-sectional view showing another aspect taken from a line A-A′ as shown in FIG. 1.

### DETAILED DESCRIPTION OF THE INVENTION

Hereinafter, certain exemplary embodiments according to the present invention will be described with reference to the accompanying drawings. Here, when a first element is described as being coupled to a second element, the first element may be not only directly coupled to the second element but may also be indirectly coupled to the second element via a third element. Further, elements that are not essential to the complete understanding of the invention are omitted for clarity. Also, like reference numerals refer to like elements throughout.

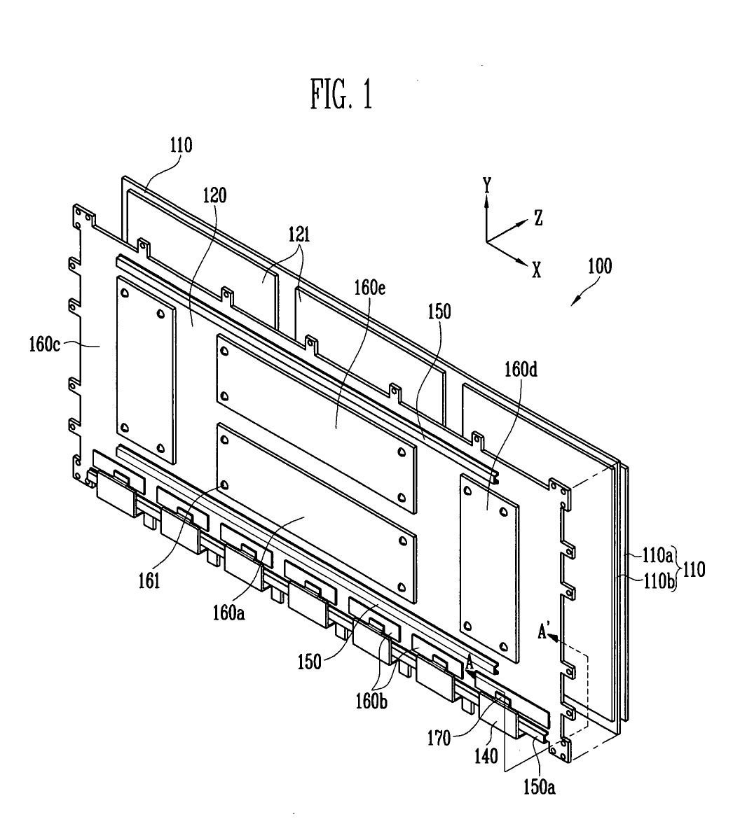

FIG. 1 is a perspective view showing a plasma display panel according to one embodiment of the present invention.

Referring to FIG. 1, the plasma display device 100 has a plasma display module 130. The plasma display module 130 includes a plasma display panel 110 for displaying an image using a gas discharge; and a chassis base 120 disposed in the rear of the plasma display panel 110 to support the plasma display panel 110.

An assembly structure of the plasma display module 130 is as follows. First, an electrode, a barrier rib and a phosphor layer are formed on a pair of glass substrates and sealed with each other, and the resulting space is then exhausted or injected with discharge gases to produce a plasma display panel 110. And, the chassis base 120 is coupled to the rear of the plasma display panel 110 to support the plasma display panel 110, and a driving circuit board 160 for driving the plasma display panel 110 is then mounted in the rear of the chassis base 120.

The chassis base 120 functions to support the plasma display panel 110 and release the heat generated in the plasma display panel 110. For this purpose, the chassis base 120 is formed by subjecting metals, such as aluminum, etc., to a casting process or a press process, the metals having a good thermal conductivity. Also, a plurality of reinforcement members 150 may be installed in the rear of the chassis base 120 to additional give rigidity to the chassis base 120 since the chassis base 120 may be deformed by “the self-weight of the plasma display module 130, or the thermal deformation caused by the heat generated in the plasma display panel 110.”

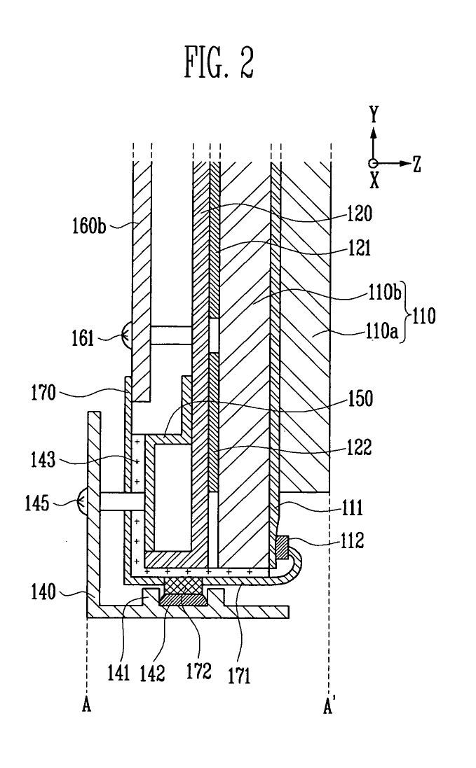

Also, provided is a signal coupling means for coupling a connection terminal provided in the driving circuit board 160 to electrodes provided in the plasma display panel 130. At this time, TCP is used as the signal coupling means in the present invention. That is to say, the plasma display panel 110 is composed of a front panel 110a and a rear panel 110b, and an address electrode 111 (see FIG. 2) is formed in the rear panel 110b. Here, the address electrode 111 and the driving circuit board 160 are packaged into the TCP and electrically coupled to each other.

The address electrode 111 of the plasma display panel 110 is electrically coupled to the driving circuit board 160 by means of a film-type flexible printed circuit board (FPCB). At this time, a TCP cover 140 is fixed and installed in reinforcement member 150a with a set screw 145 to protect TCP, the reinforcement member 150a being formed in a lower surface of the chassis base 120. The TCP cover 140 may be formed in a region except for the front surface of the panel, and formed to surround the flexible printed circuit board and the driver ICs.

Specifically, the driving circuit boards 160 are mounted in a base of the chassis base 120 using a set screw 161. Among these driving circuit boards 160, an image processing/controlling board 160a receives an image signal from an outside environment to generate a control signal required for the address electrode 111 and a control signal required for driving a display electrode (not shown), and applies the generated image signal and control signal to an address driving board 160b, and a scan driving board 160c and a sustain driving board 160d, respectively. A power source board 160e supplies a power source required for driving the plasma display device to the whole.

Among the driving circuit boards 160, each of the address driving board 160b, the scan driving board 160c and the sustain driving board 160d is coupled to plasma display panel 110 via the flexible printed circuit board 171 (see FIG. 2) so as to drive the above-mentioned plasma display panel 110. This embodiment shows a configuration where the plasma display panel 110 is coupled to the address driving board 160b via the flexible printed circuit board, and this configuration is described in detail for convenience' sake. Although not specifically shown in the drawing, this embodiment includes a configuration where the scan driving board 160c and the sustain driving board 160d are coupled to the plasma display panel 110 through the flexible printed circuit board. That is to say, the address driving board 160b as described below represents one embodiment of the driving circuit board 160, and the address electrode 111 represents one embodiment of the electrode of the plasma display panel 110 electrode.

A thermal sheet 121 is attached to the rear of the plasma display panel 110 to conduct and spread the heat generated in the plasma display panel 110 and may be further provided in the plasma display panel 110. The thermal sheet 121 may be composed of an acrylic heat insulating material, a graphite-based heat insulating material, a metallic heat insulating material, or a carbon nanotube-based heat insulating material, each of which has an excellent thermal conductivity.

FIG. 2 is a cross-sectional view showing one aspect taken from a line A-A′ as shown in FIG. 1.

Referring to FIG. 2, the plasma display device according to one embodiment of the present invention has an address electrode 111 formed in an inner surface of the rear panel 110b facing the front panel 110a. The front panel 110a and the rear panel 110b are attached to each other using a frit.

A driver IC 172 is interposed between the address driving board 160b and the address electrode 111 of the plasma display panel 110. The driver IC 172 selectively applies an address voltage pulse to the address electrode 111 of the plasma display panel 110, depending on the control signal of the address driving board 160b. Discharge cells of the plasma display panel 110 are selected by an address voltage pulse applied to the address electrode 111 and a scan voltage pulse applied to the scan electrode.

The driver IC 172, which applies the address voltage pulse as described above, is provided in a type of TCP 170. The TCP 170 has an input coupled to the address driving board 160b; and an output coupled to the address electrode 111 of the plasma display panel 110 through the flexible printed circuit board 171.

Extensions 141 are formed in an inner surface of the TCP cover 140 that surrounds and protects the flexible printed circuit board 171 and the driver IC 172, and coupled respectively to regions corresponding to the outsides of both ends of the driver IC 172.

The extensions 141 functions to fix the flexible printed circuit board 171 coupled to the driver IC 172 when the driver IC 172 is switched at a high speed, and therefore the extensions 141 reduces noises by preventing the flexible printed circuit board 171 and the TCP cover 140 from being in contact with each other by the vibration of the driver IC 172. That is to say, the TCP cover 140 of the present invention functions as a soundproofing member for protecting the TCP 170, and simultaneously minimizing the traveling of sounds produced by the vibration of the flexible printed circuit board 171 coupled to the TCP 170.

At this time, a terminal of the address electrode 111 is attached to the flexible printed circuit board 171 by means of an anisotropic conductive film (ACF) 112.

Also, nonwoven fabrics 143 are provided between the TCP 170 and the chassis base 120, and between the TCP 170 and a lower surface of the rear panel 110b, and functions to absorb vibrations produced between the chassis base 120 and the flexible printed circuit board 171 when the driver IC 172 is switched at a high speed, thereby to reduce noises. And, a silicon 142 is applied between the driver IC 172 and the TCP cover 140 to remove a vibrating space by fixing the driver IC 172 in the TCP cover 140, and therefore the silicon 142 prevents the flexible printed circuit board and the TCP cover from being in contact with each other by the vibration of the driver IC 172, which also leads to reduction in noise.

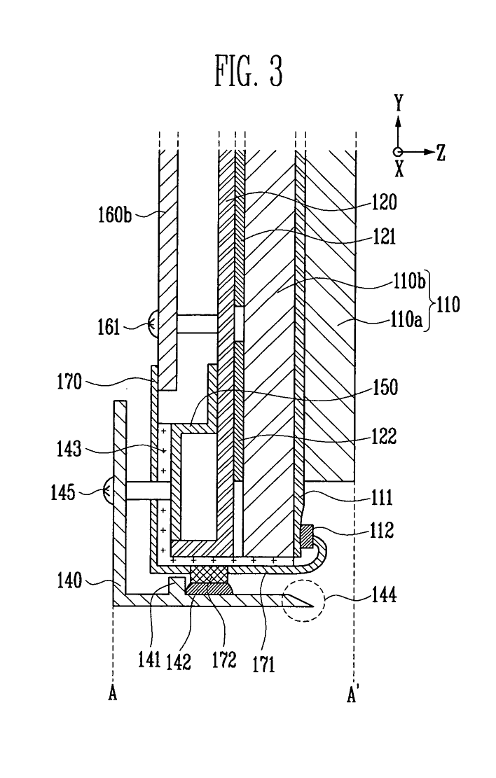

FIG. 3 is a cross-sectional view showing another aspect taken from a line A-A′ as shown in FIG. 1. Here, the detailed descriptions for the same components as in FIG. 2 are omitted for convenience' sake.

Referring to FIG. 3, the flexible printed circuit board 171 is fixed by the extension 141 to prevent the contact with the TCP cover 140, the extension 141 being formed in an inner surface of TCP cover 140 and coupled to a region corresponding to one outside surface of both ends of the driver IC 172. Preferably, the extension 141 is formed opposite to a tip 144 of the TCP cover 140. And, the tip 144 of the TCP cover 140 is formed aslant inwardly with an increasing distance to the TCP 170.

Accordingly, when the vibration of the driver IC 172 is delivered to the flexible printed circuit board 171 to produce trembles in the flexible printed circuit board 171, the extension 141 formed opposite to the tip 144 fixes the flexible printed circuit board 171, and the tip 144 of the TCP cover 140 has an increasing distance to the TCP 170. Accordingly, although vibrations are produced in the driver IC 172 to tremble the flexible printed circuit board 171, the increased distance prevents the contact of the flexible printed circuit board 171 with the TCP cover 140 to get rid of noises.

In the exemplary embodiments of the present invention, TCP is used as the signal coupling means that couples a connection terminal provided in the driving circuit board to electrodes provided in the plasma display panel, but it is possible to use other signal coupling means. In particular, the signal coupling means may be a chip on film (COF). The chip on film is obtained by installing a driver IC in TCP, followed by attaching the TPC to a display panel using a tape automated bonding (TAB) process.

As described above, the plasma display device according to the present invention may be useful to improve the quality of articles by preventing the TCP cover and the flexible printed circuit board from being in contact to each other to significantly reduce noises caused by the high-speed switching of the driver ICs because at least one extension is formed in a region other than the region in which the driver IC is disposed, wherein the driver IC is formed in an inner surface corresponding to a region in which the driver IC of the TCP is formed.

Also, the tip of the TCP cover is formed aslant inwardly with an increasing distance to the TCP, and therefore the noises may be prevented from being produced since the flexible printed circuit board is not in contact with the TCP cover due to the widened distance although the flexible printed circuit board is vibrated by the vibration in the driver IC.

Although exemplary embodiments of the present invention have been shown and described, it would be appreciated by those skilled in the art that changes might be made in these embodiments without departing from the principles and spirit of the invention, the scope of which is defined in the claims and their equivalents.

What is claimed is:

1. A plasma display device, comprising:
a plasma display panel having a front panel and a rear panel;
a chassis base installed in one surface of the plasma display panel to support the plasma display panel;
a driving circuit board installed in the other surface of the chassis base and driving the plasma display panel;
a signal coupling means for electrically coupling the driving circuit board to an electrode of the plasma display panel, the signal coupling means having driver ICs; and
a signal coupling cover that surrounds and protect the signal coupling means and has at least one extension formed in an inner surface other than a region corresponding to the driver IC.

2. The plasma display device according to claim 1,
wherein the signal coupling means is a tape carrier package (TCP).

3. The plasma display device according to claim 2,
wherein a tip of the signal coupling cover is formed so that it has an increasing distance to the tape carrier package.

4. The plasma display device according to claim 2, further comprising nonwoven fabrics between the tape carrier package and the chassis base, and between the tape carrier package and a lower surface of the rear panel.

5. The plasma display device according to claim 1, further comprising a film-type flexible printed circuit board (FPCB) for extracting an electrode of the plasma display panel to electrically couple the electrode to the driving circuit board.

6. The plasma display device according to claim 5,
wherein the flexible printed circuit board and the electrode are attached to each other by means of an anisotropic conductive film (ACF).

7. The plasma display device according to claim 1,
wherein the signal coupling cover is formed to surround the flexible printed circuit board and the driver IC except for the front surface of the panel.

8. The plasma display device according to claim 1, further comprising a buffering silicon between the driver IC and the signal coupling cover.

9. The plasma display device according to claim 1,
wherein the electrode is an address electrode formed in the rear panel.

10. The plasma display device according to claim 1,
wherein the signal coupling means is a chip on film (COF).

11. A plasma display device, comprising:
a plasma display panel having a front panel and a rear panel;
a chassis base installed in one surface of the plasma display panel to support the plasma display panel;
a driving circuit board installed in the other surface of the chassis base to drive the plasma display panel;
a tape carrier package to electrically couple the driving circuit board to an electrode of the plasma display panel, the tape carrier package being coupled to a driver integrated circuit; and
a signal coupling cover that surrounds and protect the tape carrier package and has at least one extension formed in an inner surface other than a region corresponding to the driver integrated circuit,
wherein said at least one extension prevents noise and vibration generated by the driver integrated circuit from being transmitted to a flexible printed circuit board and the signal coupling cover by preventing the tape carrier package and the signal coupling cover from coming into contact.

12. The plasma display device according to claim 11,
wherein a tip of the signal coupling cover is formed so that it has an increasing distance to the tape carrier package.

13. The plasma display device according to claim 12, further comprising nonwoven fabrics between the tape carrier package and the chassis base, and between the tape carrier package and a lower surface of the rear panel.

14. The plasma display device according to claim 11, further comprising a film-type flexible printed circuit board to electrically couple the electrode of the plasma display panel to an electrode to the driver integrated circuit.

15. The plasma display device according to claim 14,
wherein the flexible printed circuit board and the electrode are attached to each other by means of an anisotropic conductive film.

16. The plasma display device according to claim 14,
wherein the signal coupling cover is formed to surround the flexible printed circuit board and the driver IC except for the front surface of the panel.

17. The plasma display device according to claim 11, further comprising a buffering silicon between the driver integrated circuit and the signal coupling cover.

18. The plasma display device according to claim 11,
wherein the electrode is an address electrode formed in the rear panel.
